(19) United States
(12) Patent Application Publication
(10) Pub. No.: US 2005/0263593 A1
(43) Pub. Date: Dec. 1, 2005

(54) Secure, convenient, traceable voting system

(75) Inventor: Donald A. Collins JR., Dawsonville, GA (US)

Correspondence Address: DONALD A. COLLINS, JR., 387 CHESTATEE VIEW DRIVE, DAWSONVILLE, GA, 30534, US

(73) Assignee: Mr. Donald A. Collins Jr., Dawsonville, GA (US)

(21) Appl. No.: 10/709,759

(22) Filed: May 26, 2004

(51) Int. Cl. G06F 17/60

(52) U.S. Cl. 235/386; 705/12

(57) ABSTRACT

The present invention relates to a system and method of maintaining maximum security and traceability of a vote while allowing convenience to a voter using electronic devices for elections. More specifically, this invention relates to an apparatus and method of controlling any Local, State, or National election process by the use of methods of an existing financial network wherein votes are cast by the transfer of local currency from the voter's account to the candidate's account. Only voters with valid bank accounts, using approved banking access conduits and methods such as ATM's, automatic teller machines, or personal computers with secure access to bank accounts can vote in this system.

### BACKGROUND OF THE INVENTION

The present invention relates to a system and method of maintaining maximum security and traceability of a vote while allowing convenience to a voter using electronic devices for elections. More specifically, this invention relates to an apparatus and method of controlling any Local, State, or National election process by the use of methods of an existing financial network wherein votes are cast by the transfer of local currency from the voter's account to the candidate's account. Only voters with valid bank accounts, using approved banking access conduits and methods such as ATM's, automatic teller machines, or personal computers with secure access to bank accounts can vote in this system.

The United States Presidential Election of 2000 showed that state governance of the election system profoundly impacted the results of the election potentially in an inaccurate fashion. U.S. states have responsibility for registering their voters, maintaining accurate lists of registered voters, developing ballots, managing election logistics and security, and certifying and communicating election results. Furthermore, each state has a different method and budget for accomplishing these objectives. Further, as stated on Page 116 STAT. 1666 of DOCID: f:publ252.107, HELP AMERICA VOTE ACT OF 2002, Public Law 107-252, enacted by the 107th Congress, is “An Act to establish a program to provide funds to States to replace punch card voting systems, to establish the Election Assistance Commission to assist in the administration of Federal elections and to otherwise provide assistance with the administration of certain Federal election laws and programs, to establish minimum election administration standards for States and units of local government with responsibility for the administration of Federal elections, and for other purposes.” Because of this legislation, now there are multiple companies with disparate voting functions and systems being adopted by states.

Thus, it is desirable to have a countrywide common method of election systems that allows for state by state managed voter registration at banking institutions, votes to be cast on highly secure ATM's or through home, office, or other public banking conduits by transferring currency from voter's to candidates bank account, and an accurate means for counting votes in less time and at lower cost by measuring candidates' bank balances, perhaps in real-time.

According to the American Bankers Association's website, in 2003 there were 10.8 billion transactions performed on 371,000 ATM machines in the U.S. This amounts to 52 transactions for each of the 206 million voting age people in the U.S. If all of the voting could be performed in one ATM visit, then an election would amount to less than 2% usage of the ATM network system in 2003. The Personal computer (PC) has become widespread in the last 20 years. Together with enhanced encryption and security techniques, banks have turned PC's into home banking tools to help their customers manage accounts, transfer money, or pay bills.

According to The Tower Group, biller-direct payments are expected to grow from 41% of all electronic bill payments to 61% by 2005. While the number of bills paid electronically today is still under 5% of all household bills, it has been growing over 30% annually. Nielsen//NetRatings, the global standard for Internet audience measurement and analysis, reports in April of 2004 that nearly 75 percent or 204.3 million Americans have access to the Internet from home.

This wide availability of securely networked ATM's and personal computers makes the present invention practical. As described below, the present invention takes advantage of the PC and ATM to provide human interface functions without the need for proprietary voting entry hardware.

Previously proposed voting systems have all fallen short of providing the highest form of voting security, traceability, and convenience.

U.S. Pat. No. 4,373,134
to Grace, et al. discloses a magnetic card holding voter identification and voting results read by a memory based, telephone line connected, voting apparatus producing a hard copy output.

Similarly, U.S. Pat. No. 6,607,137
Morales discloses personal voting code enabled electronic device (PVCe-ballot) as the voting ballot for use in personal computers. U.S. Pat. No. 5,878,399
to Peralto discloses a computerized network of voting modules for voting precinct use.

There are multiple patents describing physical ballot punching and reading such as U.S. Pat. No. 4,641,240
to Boram who provides for a non-mechanical voting machine in which a single sheet of paper is used as a ballot.

Similarly, U.S. Pat. No. 6,081,793
to Challener et. al discloses electronically transmitted voting with alternate non-electronic paper ballots.

U.S. Pat. No. 4,015,106
De Phillipo in March, 1977 discloses a micro processor connected to a switch operated voting panel and a vote selection indicating device.

### SUMMARY OF THE INVENTION

The management of financial systems, demands a high level of attention to security. Thus, users have confidence and trust in our financial system.

In accordance with the teachings of the present invention, a system and method of voting is provided.

It is accordingly an object of the present invention to provide the most trusted and secure electronic system and method of election voting.

It is another object of the present invention to provide the most electronically traceable system and method of election voting.

It is another object of the present invention to provide the most convenient electronic system and method for election voting.

### DETAILED DESCRIPTION OF THE PREFERRED EMBODIMENT

Referring now to FIG. 1, the Committee for the Study of the American Electorate shows that the majority of the U.S. voting age population does not vote and that the percentage is decreasing with time. This is not good.

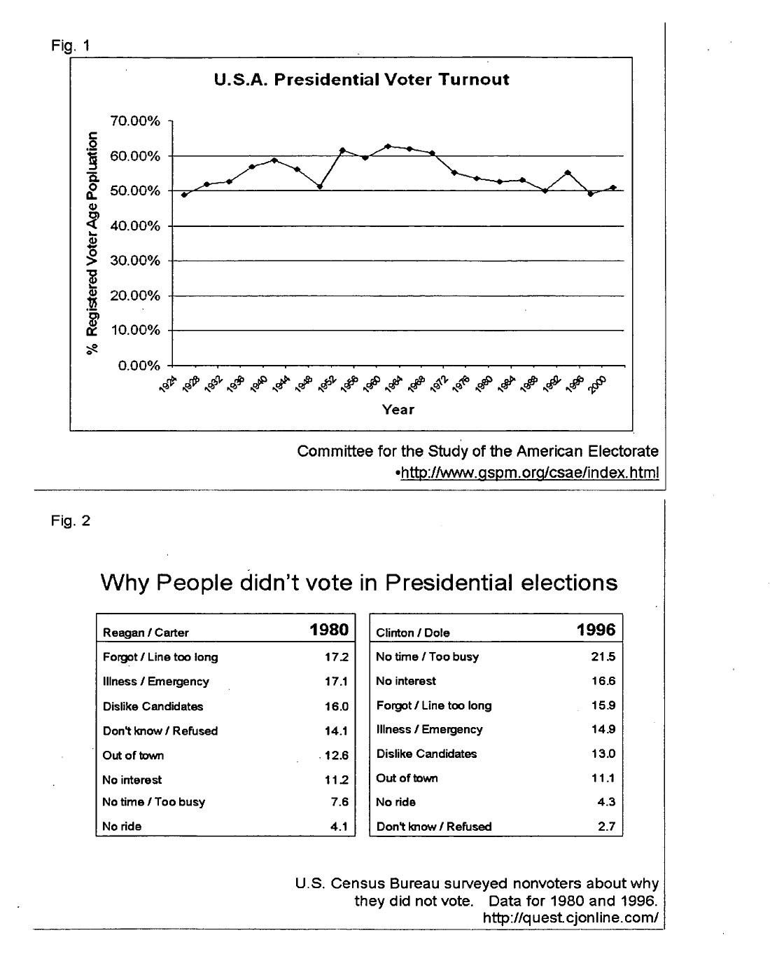

Referring now to FIG. 2, the U.S. Census Bureau showed some potential reasons why people did not vote in 1980 and 1996.

Referring now to FIG. 3, showing some potential companies who will supply voting equipment and systems to states under HAVA.

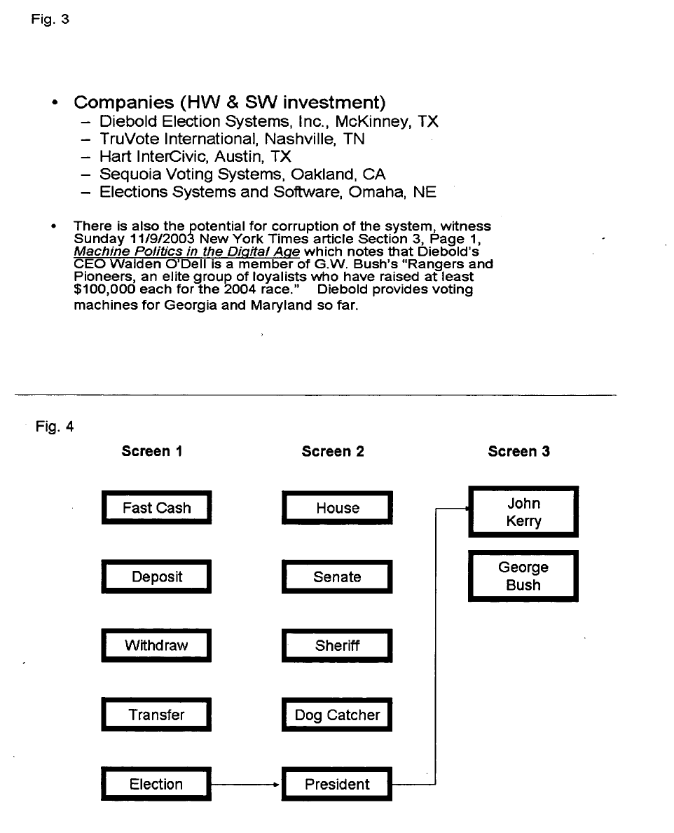

Referring now to FIG. 4, which shows three potential ATM screens that a voter would see while voting for President in the 2004 Presidential election. Leftmost, Screen 1, shows the first screen the voter views after his/her PIN is accepted. In this example, the voter, depresses the “Election” button. Depression of the “Election” button forces the program to display the middle, Screen 2, which has choices of elections; “House”, “Senate”, “Sheriff”, “Dog Catcher”, and “President”. In this example, the voter depresses the “President” key which forces the program to display the choices for Presidential election on rightmost, Screen 3, showing choices of “John Kerry” and “George Bush”. In this example, the user depresses the “John Kerry” button which causes the program to transfer some denomination of currency from the voter's bank account to John Kerry's bank account, and it disables further future voting for President by this account holder by removing “President” button from Screen 2.

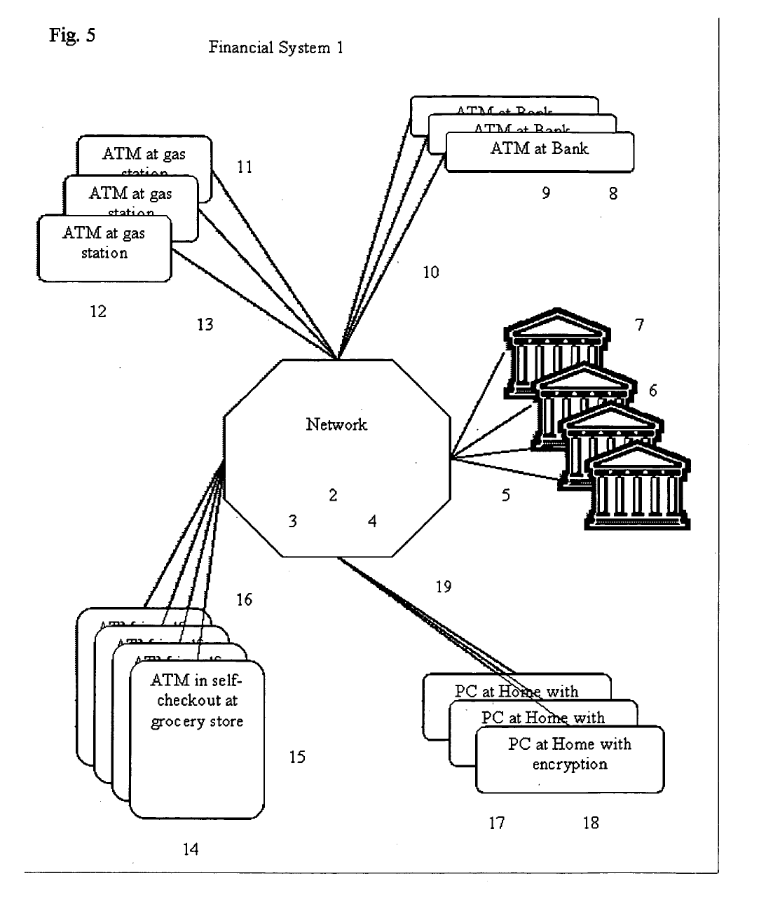

Referring now to FIG. 5, Financial system 1 including the network 2, which includes the software 3 for the network and the hardware servers and connections 4 for the network. Connected to the network are banks 6 through connection 5 with software 7; ATM's at banks 8 with software 9 and with connection 10 to the network; ATM's at gas stations 11 with software 12 and with connection 13 to the network; ATM's in grocery stores 14 with software 15 and with connection 16 to the network; and PC's with encryption at home 17 with software 18 and with connection 19.

Network 2 is comprised of servers 4 running software 3 with wiring connections to the other systems on the network. These servers are typically the property of the bank, but can also be owned by consortia.

Banks 6 are connected to the network by 5 and provide access to the network for customers wishing to transfer funds for various reasons by using software 7.

ATM's at banks 8 are purchased and maintained by banks for the purpose of providing convenience allowing their customers to withdraw or deposit funds through software 9 any day or time and are connected to the network by connection 10.

ATM's at gas stations 11 and ATM's at grocery stores 14 are purchased and maintained by gas stations and grocery stores respectively so as to provide convenience to their customers in a similar way that ATM's at banks 6 provide this service.

Personal Computers PC's 17 with encryption and system software 18 at home are purchased by individual users who can then connect to the network by connection 19 to their bank 6 for the purpose of monitoring their accounts, transferring funds, or paying bills.

All of the above functions with their network connections can be considered acceptable for use as election voting machines. Ballot screens as shown in FIG. 4 can be downloaded over the network to each of the ATM's 8, 11, 14 and to home PC's 17 described above. In this way there is no special hardware as required by the companies shown in FIG. 3. There is only new voting software and ballot images required to be developed.

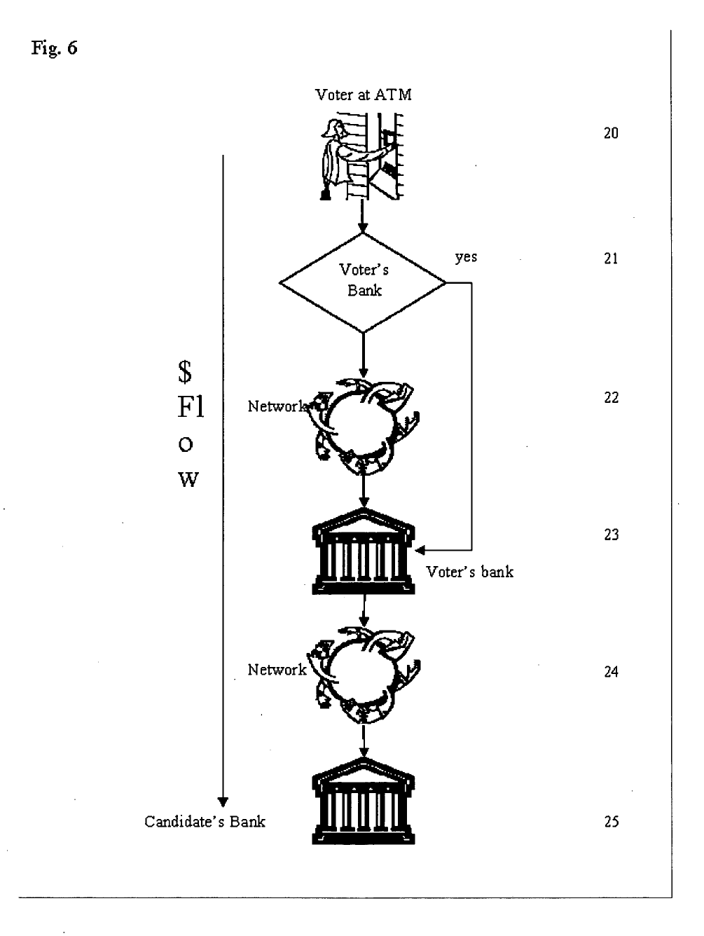

Referring now to FIG. 6, showing one example of how a vote is cast in the election by using the financial system. Step 20 shows a voter at the ATM at her bank (or not at her bank) with bank card inserted is shown screens as in FIG. 4 and votes for president as described in paragraph 27 above. Step 21 shows a decision that must be made if the user is standing at an ATM at her bank or not. If she is using her bank then there is no need for the transaction to get onto network 1 shown in FIG. 5 at this time. If she is not at her bank, then step 22 occurs and the ATM she used attaches onto network 1 as shown in FIG. 5 in order to transfer instructions to her bank. Referring now to step 23, voting instructions have arrived at the bank of the user and those instructions generated in step 20 will begin the wire transfer of funds from the voter's account to the presidential candidate's bank account. In order to transfer these funds, the user's bank must go onto network 1 shown in FIG. 5 at step 24 to send the funds to the candidate's bank and bank account in step 25.

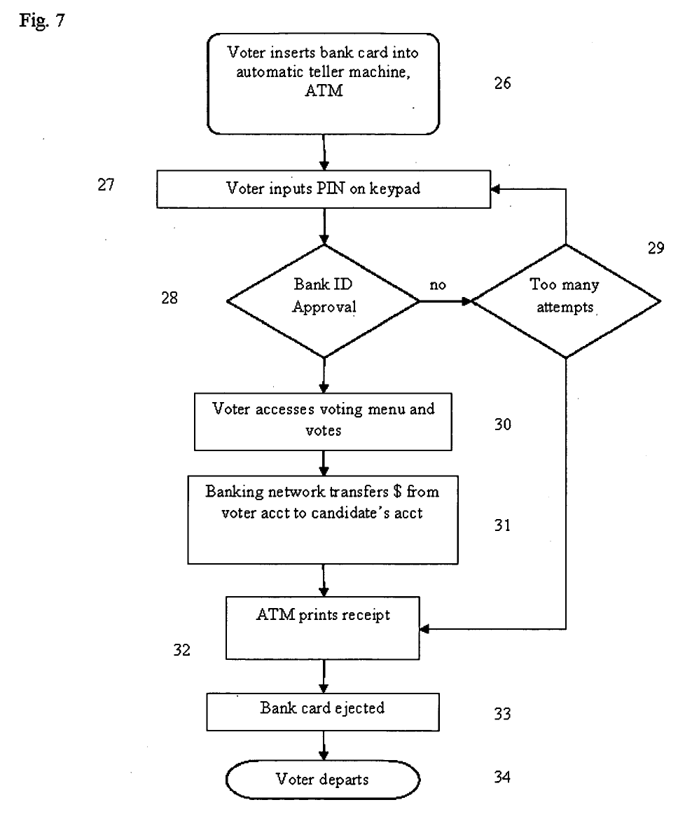

Referring now to FIG. 7, it shows the process for entering one's account and voting at an ATM whether it be at a bank or gas station or in a grocery store. Step 26 shows the voter inserting their bank card into the ATM. Step 27 shows that the voter inputting their Personal Identification Number PIN by keypad or touch screen into the ATM. Step 28 shows the ID being accepted or rejected. Step 29 shows the number of attempts at ID input as being exceeded or not. Step 30 shows the voter accessing their account and getting to the voting screen as shown in FIG. 4 and voting as described in paragraph 27 above. Step 31 shows the software in the bank acting on the instructions of the voter and transferring funds from the voter's account to the account of the presidential candidate. Step 32 shows the ATM printing a receipt with a transaction number for the voter to take away with them at step 34 after step 33 ejects their bank card from the machine.

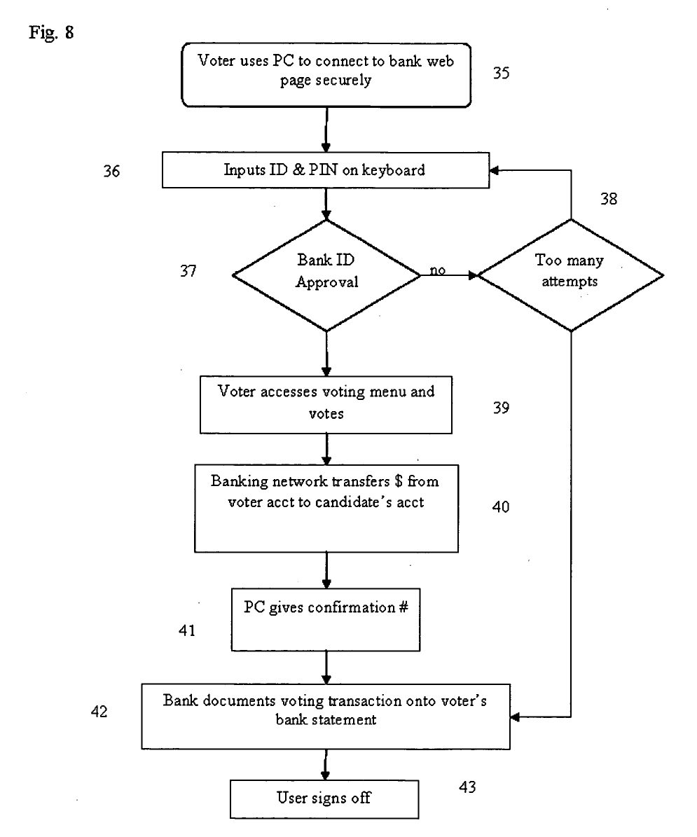

Referring now to FIG. 8, it shows the process for entering one's account and voting at a PC. Step 35 shows the voter accessing the internet and attaching to their bank's website. Step 36 shows that the voter inputting their Identification number and Personal Identification Number PIN by keyboard into the website. Step 37 shows the ID being accepted or rejected. Step 38 shows the number of attempts at ID input as being exceeded or not. Step 39 shows the voter accessing their account and getting to the voting screen as shown in FIG. 4 and voting as described I paragraph 27 above. Step 40 shows the software in the bank acting on the instructions of the voter and transferring funds from the voter's account to the account of the presidential candidate. Step 41 shows the bank website presenting the voter with a confirmation number and description of the vote. Step 42 shows that the transaction will be shown on the voter's bank account statement electronic or printed. Step 43 shows the user signing off of the bank website.

Although the invention has been described with particular reference to certain preferred embodiments thereof, variations and modifications of the present invention can be effected within the spirit and scope of the following claims. It is evident that those skilled in the art may now make numerous other uses and modifications of and departures from the specific embodiments described herein without departing from the inventive concepts.

### BRIEF DESCRIPTION OF THE DRAWINGS

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 last 80 years of U.S Presidential voter turnout

FIG. 2 reasons why people didn't vote in 1980 & 1996

FIG. 3 potential companies selling voting equipment

FIG. 4 an example screen for voting on an ATM

FIG. 5 a block diagram of the electronic voting system

FIG. 6 a block diagram showing a number of ways a vote can move through an existing financial system

FIG. 7 flow diagram illustrating a vote being cast from an ATM; and

FIG. 8 flow diagram illustrating a vote being cast from a personal computer

1. A system and method to transfer funds, is local currency from voter's secure bank account to candidate's secure bank account, as instructed by said voter, for the purpose of registering a vote for said candidate by said voter in an election.

2. The system of claim 1 wherein said existing financial system hardware, software, keyboard, display, or printer is used to view, select, or record voter choices.

3. The system of claim 1 wherein said existing financial system software, hardware, and network is used to register a vote during a predefined time duration.

4. The system of claim 1 wherein said existing financial system software, hardware, and network is used to transport a programmable ballot image for use by said voter to register a vote.

5. The system of claim 1 wherein said existing financial system software, hardware, and network is used to display a programmable ballot image on a touch screen or display system used by said voter to register a vote.

6. The system of claim 1 wherein said existing financial system including automatic teller machine located at a bank, gas-station, grocery store, or other conveniently accessible location is used to register a vote.

7. The system of claim 1 wherein said existing financial system includes using a personal computer to register a vote.

8. The system of claim 1 wherein said existing financial system hardware, regardless of local, is used to print a paper receipt that contains said voter's choices.

9. The system of claim 1 wherein said voter's electronic or paper bank account statement shows voter's past voting activity for the statement.

10. The system of claim 1 wherein said candidate's electronic or paper bank account statement shows cumulative voter activity for said candidate and can be used to show real-time, accurate election results for that candidate.
